(19) United States
(12) Patent Application Publication
(10) Pub. No.: US 2024/0424761 A1
(43) Pub. Date: Dec. 26, 2024

(54) Methods and Compositions for Improving Material Strength and Toughness Using Tape-Based Quasi-Composites

(71) Applicant: College of William & Mary, Williamsburg, VA (US)

(72) Inventors: Benjamin H. Skopic, Arlington, VA (US); Hannes C. Schniepp, Williamsburg, VA (US)

(73) Assignee: College of William & Mary, Williamsburg, VA (US)

(21) Appl. No.: 18/754,119

(22) Filed: Jun. 25, 2024

Related U.S. Application Data
(60) Provisional application No. 63/510,187, filed on Jun. 26, 2023.

(51) Int. Cl. B32B 3/14; B32B 3/18; B32B 7/03; B32B 27/08; B32B 37/06

(52) U.S. Cl. CPC B32B 3/14; B32B 3/18; B32B 7/03; B32B 27/08; B32B 37/065; B32B 2250/05; B32B 2307/558; B32B 2307/7376

(57) ABSTRACT

Methods and compositions are described for producing high-performance materials. These materials utilize layers of stacked tapes wherein the tapes in any given layer are offset by between 0.1 degrees and 45 degrees from tapes of adjacent layers. At least three roughly parallel tapes are included within each layer of tapes, and the tapes have an aspect ratio of at least 20. The maximum thickness of a tape within a given layer is 5 mm. The resulting materials have significantly improved strength and/or toughness. The compositions can be used as stand-alone materials or combined with other materials to form tape-reinforced composites.

### CROSS-REFERENCE TO RELATED APPLICATIONS

The present application claims priority under 35 U.S.C. § 119(e) to (i) U.S. Provisional Patent Application No. 63/510,187 filed Jun. 26, 2023. The entire disclosure of this application is incorporated by reference herein.

### FEDERALLY SPONSORED RESEARCH AND DEVELOPMENT

This invention was made with government support under Grant No. DMR-1905902 awarded by the National Science Foundation. The government has certain rights in the invention.

### BACKGROUND OF THE INVENTION

Fiber-reinforced composites are widely used materials in the aerospace, automotive, industrial, and sports industries for applications requiring a high strength-to-weight ratio material. Fiber-reinforced composites achieve their mechanical properties in part by transferring stress from the fibers to a binding matrix. Adhesive forces facilitate the load transfer between the fiber and matrix, and higher adhesion typically results in more efficient load transfer and an overall higher performance composite. While efforts can be made to increase the interfacial fiber-matrix adhesion, any such efforts to improve adhesion are acting over a relatively small surface area due to the cylindrical morphology of the fibers.

Flattened or ribbon-like fibers offer higher surface area to increase fiber-matrix adhesion and can provide excellent mechanical performance. Ribbon-reinforced composites have been produced and tested. Often, the mechanical performance of a ribbon-reinforced composite is somewhat limited by the mechanical properties of the ribbon material when, for example, the ribbons are made of metals or glass.

In nature, certain animals make composite structures using ribbons that have very little matrix. For example, Zhang et al. (RSC Advances 5, 1640-1647 (2015) and Materials Science and Engineering: C 33, 3206-3213 (2013)) teach that Antheraea (A.) pernyi, A. assamensis, and A. mylitta silkworms make cocoons featuring ribbon silk fibers with an aspect ratio of roughly 1:9 and have 75% less adhesive than cylindrical silkworm fibers. Within the cocoon, sericin acts as the matrix and the silk provides the fiber reinforcement. The cocoons made with ribbons can have roughly twice the strength, twice the stiffness and six times the toughness of cocoons made of cylindrical fibers. This performance enhancement comes from the adhesive capabilities in between each junction of two ribbons within the cocoon. These junctions have enough adhesive strength from the thin film of sericin to transfer load between contacting ribbons like two adhesive tapes stuck together. Thus, these cocoons are ribbon-reinforced composites that fall into a class that can be called “tape-reinforced composites” given the adhesive junctions. The mechanical properties of these tape-reinforced composites are driven by the characteristics of each tape-tape junction.

The recluse spider (Loxosceles loeta) builds its web using a silk ribbon approximately 50 nm thin and 7 μm wide, with an aspect ratio of roughly 1:150 (Schniepp et al., “Brown recluse spider's nanometer scale ribbons of stiff extensible silk”, Advanced Materials 25, 7028-7032 (2013)). Each silk-silk junction behaves like a tape-tape junction found within a tape-reinforced composite. Skopic et al. (“Self-strengthening tape junctions inspired by recluse spider webs”, Materials Horizons (2022) doi:10.1039/d2mh00403h)) discovered the conditions that allow these tape-tape junctions to self-strengthen such that the silk breaks before the adhesive junction. This would be surprising for any adhesive junction; however, it is particularly surprising for recluse silk because it lacks a dedicated adhesive. The silk's adhesion relies solely on weak van der Waals (vdW) forces formed from direct silk-silk contact.

There is a long-standing need in the art for high performance materials and composites.

### SUMMARY OF THE INVENTION

Methods and compositions are described for producing high-performance materials comprising multiple layers of stacked tapes wherein there are at least four stacked layers of tapes, wherein at least two layers of tapes are offset by between 0.1 degrees and 45 degrees from tapes of adjacent layers, wherein at least three roughly parallel tapes comprise each layer of tapes, and wherein said tapes have an aspect ratio (defined as the ratio of the width of the tape to the thickness of the tape) of at least 20. The maximum thickness of one of said tapes within a given layer is 5 mm. The longest dimension of the tapes is the length, which is at least two times the width of the tape, and often is at least five times the width of the tape, or at least 10 times the width of the tape. The offset layers of tape contact each other at junctions, and the adhesion forces at the junctions contributes substantially to improved strength and toughness of the composite material. The tape compositions described herein, referred to as tape-based quasi-composites, have enhanced toughness and strength relative to equivalent masses of the tapes when they are not stacked at offset angles.

The layers of tapes in tape-based quasi-composites are offset at an angle between 0.1 degrees and 45 degrees from each adjacent layer of tapes. Note that this offset angle can be in either direction, positive or negative, and thus from any fixed reference point, the absolute value of this offset angle is between 0.1° and 45°. The sum of the offset angles of can add up to any number. One advantage of having consistently offset angles with balanced distribution of tapes is that the resulting tape-based quasi-composite becomes substantially isotropic. This can be a particular advantage in reinforced composites relative to prior art fibers such as Kevlar® fibers or carbon fibers, which are not directionally isotropic. However, the offset angles do not have to be consistent between layers.

Within an individual layer of tapes, there are three or more tapes. While these tapes within a layer are not necessarily parallel, they are aligned in a substantially parallel manner. Distortions and imperfections in the tape, or intentional or unintentional misalignment can occur, but average vectors through the longitudinal axis of any such tapes should be within five degrees of parallel to one another.

The distance between said three or more tapes within an individual layer of a tape-based quasi-composite can be any distance less than 20 times the width of the largest tape width within said layer. All tapes within a given layer, or within the entire structure, need not have the same dimensions. For example, one tape can be wider than another tape. That said, it is generally advantageous for all the tapes within a given layer to have the same thickness.

Tapes from different layers contact each other at junctions. In some embodiments, the junctions are welded. For example, thermoplastic polymer tapes can be thermally welded at the junctions, as occurs during 3-D printing. Mechanically, this welding process allows two distinct layers to be co-dissolved in solvent, enabling sufficient entanglement to form an integral single layer at the junction upon evaporation of the solvent. In other embodiments, the tapes can be adhesively bonded at the junctions, for example, by formulating tapes with an adhesive layer. In other embodiments, the tapes can be chemically bonded at junctions, for example via click chemistry, UV-activated bonding, or any other suitable chemical methods.

In other embodiments, the junctions are not welded in place, and no adhesives are used. In such embodiments, intermolecular forces such as van der Waals forces provide the adhesion between layers. Such embodiments are termed low-adhesion quasi-composites, or alternatively, referred to as stacked quasi-composites.

The tapes can have a variety of dimensions, provided the aspect ratio is at least 20, and provided the length to width ratio is at least two. Accordingly, the length to thickness ratio must be at least 40. The thickness of a tape can be any thickness less than five mm.

Any suitable material can be used to form the tapes, including but not limited to metals, carbon materials, and polymers. Polymers can be naturally occurring polymers or man-made polymers.

The compositions of layered offset tapes can be utilized as a stand-alone material, or can be combined with other materials. For example, a tape-based quasi-composite can be incorporated into a polymeric matrix to produce a tape-reinforced composite having improved material properties (e.g., strength and toughness) relative to the polymeric matrix in the absence of the tape-based quasi-composite. Such tape-reinforced composites can be produced using methods known in the art for incorporating additives into polymers.

Compositions of tape-based quasi-composites can be manufactured in a variety of ways. For example, compositions can be made by producing tapes using methods known in the art, then assembling them to produce the desired structure. In other embodiments, compositions of layered tapes are produced by 3-D printing. In other embodiments, compositions of layered tapes are produced by layering sheets of edge-bonded tapes.

Suitable application for these compositions include, but are not limited to: medical, military, sporting goods, aerospace, and automotive products, or any other applications benefitting from the improved material properties that can be obtained using the methods described herein.

### BRIEF DESCRIPTION OF DRAWINGS

FIG. 1 shows a schematic, overhead perspective drawing of a single layer of tapes aligned parallel to each other.

FIG. 2 is a schematic, overhead perspective drawing showing one tape layered at a suitable offset angle over a second tape. The darker shaded rhombus area in the overlap region comprises the junction region of the two tapes.

FIG. 3 is a schematic drawing of an exploded view of a tape-based quasi composite wherein each layer of tapes is offset at an angle of 15 degrees from adjacent layers of tapes.

FIG. 4A is a schematic image of a thin film. FIG. 4B is a schematic image of the thin film in FIG. 4A wherein parallel ribbons of the film have been excised to yield a layer of parallel tapes joined at the edges. FIG. 4C is a schematic image showing two layers of such edge-joined parallel tapes stacked on top of each other at an offset angle of 30 degrees. FIG. 4D is a schematic image showing six layers of edge-joined parallel tapes stacked on top of each other, all at an offset angle of 30 degrees relative to the previous layer to yield a tape-based quasi-composite that is substantially isotropic.

FIG. 5 is an image of superimposed stress-strain curves for control tapes, stacked tape-based quasi-composites, and welded tape-based quasi-composites described in Example 1.

### DETAILED DESCRIPTION OF THE INVENTION

Methods and compositions are described for producing high-performance materials comprising multiple layers of stacked tapes wherein there are at least four stacked layers of tapes, wherein at least two layers of tapes are offset by between 0.1 degrees and 45 degrees from tapes of adjacent layers, wherein at least three roughly parallel tapes comprise each layer of tapes, and wherein said tapes have an aspect ratio of at least 20.

As described herein, the term “tape” means a roughly cuboid structure with the appearance of a flattened fiber or ribbon having a length, width, and thickness. The structure can be a rectangular prism, but neither the length, width, nor thickness needs to be constant. When the tape is laid on a flat surface, all cross-sectional slices are not required to have the same area. Instead, 90% of the cross-sectional slices of the tape along any given plane must have areas within 10% of the average area of a cross-sectional slice within that plane.

The thickness is the smallest of the three dimensions of the tape, and the maximum average thickness of a tape is 5 mm. The next largest dimension of the tape is the width of the tape, which must be at least 20 times the thickness of the tape. In some embodiments, this aspect ratio is at least 50, or in some embodiments at least 100. The longest dimension of each tape is the length, which must be at least two times the width of the tape, or in some embodiments at least five times the width of the tape, or in some embodiments at least ten times the width of the tape.

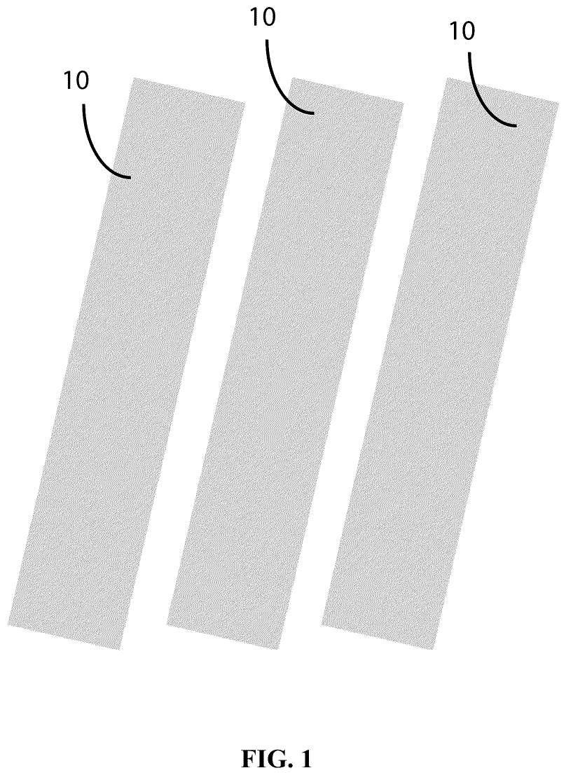

The tapes are arrayed in layers, with each layer comprising at least three tapes aligned in roughly parallel orientations, as shown in FIG. 1. When a layer of tapes is placed on a surface, the dimension perpendicular to the surface is the thickness of the tapes. The three or more roughly parallel tapes 10 are separated such that the distance between the tapes is any distance less than 20 times the width of the largest tape width within said layer. All tapes within a given layer, or within the entire structure, need not have the same dimensions. For example, one tape can be wider than another tape. Generally, it is advantageous for all the tapes within a given layer to have the same thickness, or nearly the same thickness.

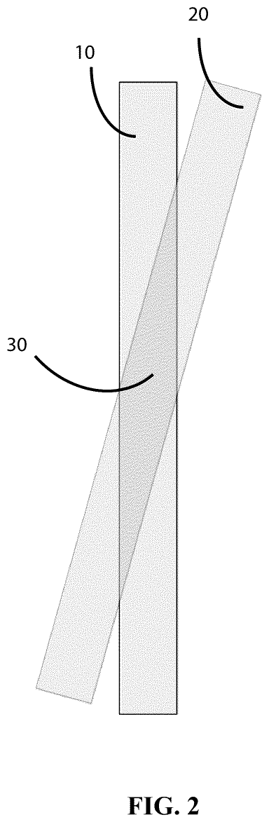

The offset layers of tape contact each other at numerous junctions with tapes from adjacent layers. FIG. 2 is a schematic drawing showing one tape layered at a suitable offset angle over a second tape. The darker shaded rhombic area in the overlap region comprises the junction region of the two tapes. The first tape 10 is a roughly cuboid structure with the appearance of a flattened fiber or ribbon having a length, width, and thickness. The length of the first tape 10 is the longest axis, and the thickness of the first tape 10 is the shortest axis. The ratio of the length of the first tape 10 to its width is at least two. The second tape 20 is also a roughly cuboid structure with the appearance of a flattened fiber or ribbon having a length, width, and thickness. The length of the second tape 20 is the longest axis, and the thickness of the second tape 20 is the shortest axis. The ratio of the length of the second tape 20 to the width is at least two. As shown in FIG. 2, the junction formed by any two tapes 10 and 20 from adjacent layers does not form a single point of contact, but rather an area 30, and the area of each junction is determined by the width of the tapes and the offset angle between the two tapes such that the smaller the absolute value of the offset angle, the larger the junction. The offset angle refers to the angle formed between the vectors that run parallel to the length axis of the two ribbons. The offset angles between tapes of adjacent layers are between about 0.1 degrees and about 45 degrees along the long axis of the tapes from tapes of an immediately adjacent layer. The offset angles can be constant throughout the composition or varied.

Note that the offset angle between tapes within a given layer will be zero (i.e., the tapes are parallel) or close to zero, but not more than 5 degrees for tapes that are roughly parallel.

The offset angle is measured in degrees and can have positive or negative values, depending on the direction of deviation. If the two ribbons are perfectly parallel, the offset angle will be zero. As the deviation increases, the offset angle will become larger in magnitude. According to the methods described herein, the absolute value of the offset angle between tapes in adjacent layers forming junctions is between about 0.1 degrees and about 45 degrees.

The offset angles between adjacent layers can be constant (e.g., 30° rotation in each layer), or can be varied (e.g., 20°, then 10°, then 40°, then 30°, then 5°, then 5°, then 40°, then 40°). The offset angles can always be in the positive direction, or always be in the negative direction, or can alternate back and forth between positive and negative angles, or can have any other pattern, or there could be no discernible pattern. The sum of the offset angles can add to any number. One advantage of having consistently offset angles arrayed in a reasonably balanced distribution is that the resulting tape-based quasi-composite becomes substantially isotropic. As used herein, the term “substantially isotropic” means that the mechanical performance does not deviate more than ten percent as a function of the direction of applied load.

The number of stacked layers of tapes is four or higher to produce the claimed tape-based quasi-composite compositions. An assembly of at least four stacked layers of roughly parallel tapes, as described herein, is referred to as a tape-based quasi-composite, or sometimes simply as a quasi-composite. More stacked layers, such as 10 layers, or 100 layers, can be utilized in the tape-based quasi-composites.

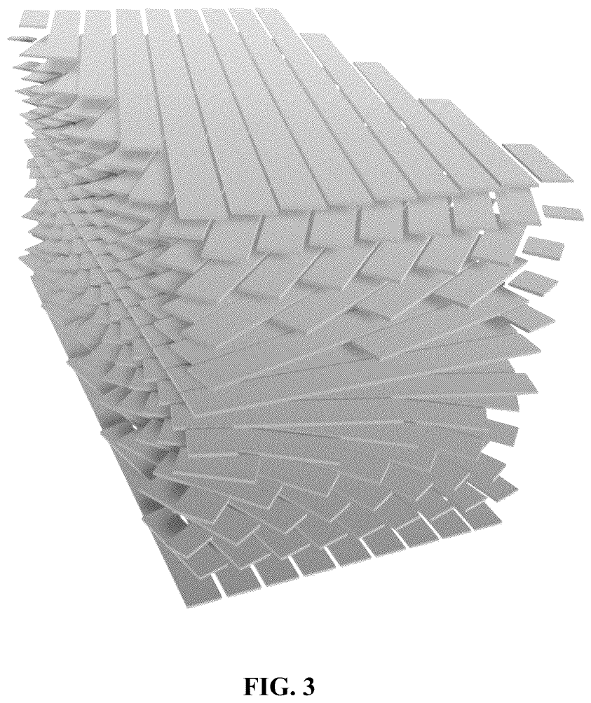

FIG. 3 provides a schematic diagram of an exploded view of a stacked, tape-based quasi-composite. In this exploded view diagram, the layers of tapes are shown with significant spacing between each layer of tapes for ease of viewing. In this diagram, the offset angle between each set of layers is 15 degrees.

The arrangement of at least four stacked layers of tapes, where each tape has a length, width, and thickness, and the length is the longest axis while the thickness is the shortest axis, allows for a structured and organized composite material. This specific configuration ensures that the tapes are aligned in a manner that improves their mechanical properties, such as strength and toughness.

By ensuring that the ratio of the length of a given tape to its width is at least two, and the ratio of the width of a given tape to its thickness is at least 20, the tape-based quasi-composites leverage the high aspect ratio of the tapes to enhance the load-bearing capacity and stress distribution within the composite material. This high aspect ratio contributes to the overall mechanical performance of the material.

The inclusion of at least three roughly parallel tapes in each layer ensures that the load is distributed across multiple tapes, reducing the likelihood of failure at any single point. This redundancy in the structure enhances the durability and reliability of the composite material.

The offset angles between about 0.1 degrees and about 45 degrees along the long axis of the tapes from tapes of an immediately adjacent layer increases the contact area at the junctions between tapes, improving the adhesion and load transfer between layers.

The maximum spacing between the at least three roughly parallel tapes within a given layer being no more than twenty times the width of the tape with the biggest width within a given layer ensures that the tapes are closely packed, which enhances the overall structural integrity and mechanical performance of the composite material. This does not preclude single tapes being a greater distance apart, or overlapping with an adjacent tape, as long as at least three roughly parallel tapes are spaced no more than 20 times the width of the tape with the largest width within a given layer.

The maximum thickness of a tape within a given layer being 5 mm ensures that the tapes are thin enough to maintain a high contact surface area between tapes of adjacent layers relative to the cross-sectional area of the tapes.

In some embodiments, tapes are made using an extrusion process. For example, in one embodiment, a polymer is dissolved, then the resulting polymer solution is extruded onto a surface to produce a thin film after the solvent evaporates. This thin film itself can be a tape, or the film can be cut into ribbons to produce tapes. An adhesive coating can be added to these tapes to enhance adhesion. These tapes are then stacked to produce tape-based quasi-composites.

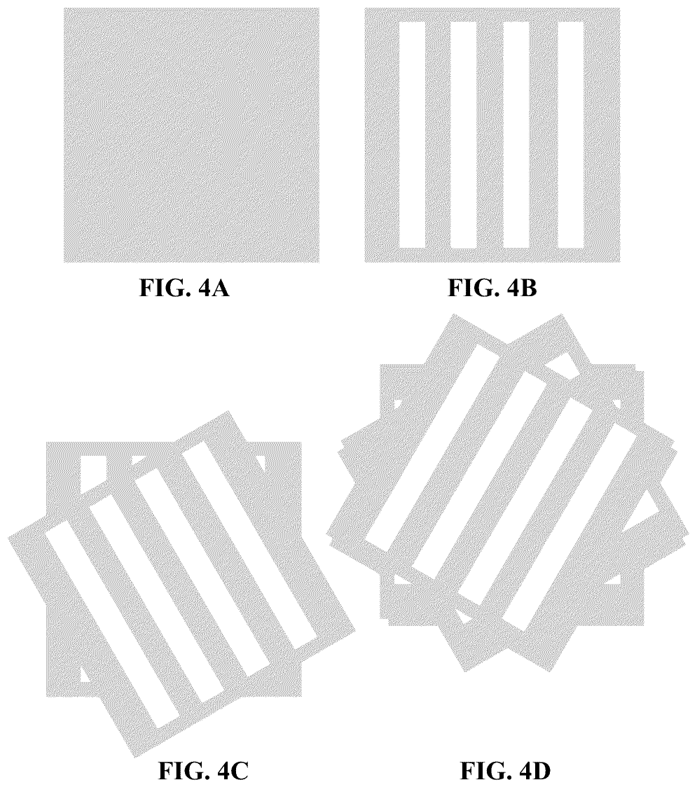

In another embodiment, as shown in FIG. 4, a thin film is produced (FIG. 4A), and then portions of the film are excised to produce a layer of parallel tapes joined at the edges (FIG. 4B). A second, equivalent excised thin film is stacked on top of the first one at an appropriate offset angle (FIG. 4C). Subsequent layers are added to produce a “bordered tape-based quasi-composite”, as shown in FIG. 4D, which depicts six layers, all offset 30 degrees from the previous layer for a cumulative offset of 180 degrees. The joining edges can be removed (not shown in FIG. 4).

In another embodiment, 3-D printing is used to produce tape-based quasi-composites. 3-D printing can be used to produce one individual layer at a time. The layers are then assembled into tape-based quasi-composites, or solvent printing can be used to print, layer-by-layer, a tape-based quasi-composite. In the former method, where the printing is used to produce single layers or tapes, dried tapes are stacked onto each other at offset angles to produce tape-based quasi-composites that utilize only intermolecular forces to bond the junctions. Such tape-based quasi-composites having junctions between adjacent layers formed by stacking the layers of tapes are referred to as stacked, tape-based quasi-composites. Another method to form stacked, tape-based quasi-composites is to use pressure sensitive adhesive compounds on the tapes such that intermolecular forces form a adhesive junctions. In contrast, when 3-D printing is used to directly print one layer of tapes onto a previous layer, a weld is formed at the junctions as the solvent used to carry the polymer being printed can dissolve portions of the previously laid layer. The co-dissolved polymers from two distinct layers can then interact and become entangled in solution, yielding an integral, welded junction upon evaporation of the solvent. Such tape-based quasi-composites having welded junctions are referred to as welded, tape-based quasi-composites. Another method to form welded, tape-based quasi-composites is to use adhesive compounds on the tapes such that a weld is formed at junctions.

Any other suitable methods can be used to create compositions of tape-based quasi-composites.

Any material that can be formed into tapes as defined herein can be used to make tape-based quasi-composites. For example, suitable materials include polymers such as naturally occurring polymers, synthetic polymers, and semi-synthetic polymers. For example, some suitable polymers include polyethylene, polypropylene, polyvinyl chloride, polystyrene, polyethylene terephthalate, polyurethane, poly(methyl methacrylate), polyethylene glycol, polycarbonate, polyvinylidene fluoride, polytetrafluoroethylene, polyamide, polyacrylonitrile, polybutadiene, polylactic acid, polyvinyl alcohol, polyether ether ketone, polyimide, polyphenylene oxide, polyphthalamide, acrylonitrile butadiene styrene (ABS), polybutylene succinate, polyhydroxyalkanoates, poly-paraphenylene terephthalamide, and polybutylene terephthalate. For example, in Example 1 below, tapes and tape-based quasi-composites were made from ABS plastic which has a bulk tensile strength of 23 MPa. By forming tape-based quasi-composites, the tensile strength and toughness were substantially improved. Nevertheless, the resulting tensile strength was less than some fiber-reinforced composites made with high-performance fibers from carbon fiber, Kevlar, ultra-high molecular weight polyethylene (UHMWPE), or polyamide (nylon).

These high-performance fiber materials can be produced in ribbon form rather than fiber form and used to produce tape-based quasi-composites as described herein.

The tape-based quasi-composites can be useful in a wide variety of applications, including but not limited to the aerospace, automotive, industrial, and sports industries, or any other industry benefiting from the high performance of these materials.

In some embodiments, tape-based quasi-composites are combined with other materials to produce tape-reinforced composites by incorporating tape-based quasi-composites as the reinforcing material into a polymeric, metallic, or ceramic matrix. The resulting high-performance materials can be used in any applications benefiting from the properties of the tape-reinforced composites. For example, in certain embodiments, UHMWPE tape-based quasi-composites are used to reinforce a polymeric matrix wherein the polymer is a thermoset or thermoplastic polymer. For many structural applications, thermoset polymers are used as the matrix, including but not limited to thermosets made from epoxies, phenolics, cyanate esters, bismaleimides, benzoxazines, vinyl esters, polyesters, and polyimides. In other embodiments, thermoplastic polymers are used as the matrix, including but not limited to commodity thermoplastics such as polyethylene, polyethylene terephthalate, polybutylene terephthalate, polyurethane, polybutylene succinate, polycarbonate, acrylonitrile butadiene styrene, polyamides, and polypropylene. In other embodiments, high-performance thermoplastic resins, including but not limited to polyetheretherketone (PEEK), polyetherketone (PEK), polyamide-imide (PAI), polyarylsulfone (PAS), polyetherimide (PEI), polyethersulfone (PES), polyphenylene sulfide (PPS) and liquid crystal polymer (LCP), are used as the polymeric matrix which is reinforced by tape-based quasi-composites.

### EXAMPLES

The examples that follow are intended in no way to limit the scope of this invention but are provided to illustrate the methods of the present invention. Many other embodiments of this invention will be apparent to one skilled in the art.

### Example 1

Solvent-cast printing (SCP) was used to make and layer polymeric tapes. In this process, a polymer is dissolved in a suitable solvent and then the solution (analogous to ink in a printing process) is extruded through a syringe or other suitable device. When the solvent evaporates, a homogenous polymer thin film with well-defined width and thickness (i.e., tape) is left behind without any adhesive. Combined with a three-dimensional (“3-D”) bio-printer, SCP can be done layer-by-layer to build a 3-D tape-based quasi-composite.

We made tape-based quasi-composites by either (i) letting the tapes dry before assembling the quasi-composite, or (ii) directly printing the layers on top of each other. When using the former method, the stacked tapes rely on van der Waals forces for adhesion at the junctions, thereby yielding low-adhesion, stacked, tape-based quasi-composites. In the latter method, the tapes within the directly printed quasi-composites are welded together due to the top tape partially dissolving the already dried bottom tape, thereby yielding welded, tape-based quasi-composites.

Airwolf® 3-D printer grade natural color acrylonitrile butadiene styrene (ABS) was dissolved in Fisher Chemical™ high performance liquid chromatography (HPLC) grade ethyl acetate for use in SCP. The solution was loaded into a syringe with a 22-gauge tipless needle and extruded at 0.27 μL/s using an OpenBuilds 3-D bio-printer.

All printing was done on glass slides with a sacrificial thin film (˜50 nm) of Fisher Chemical™ 98-99% hydrolyzed, low molecular weight polyvinyl alcohol (PVA). The film of PVA was created by first dissolving PVA in purified, deionized water at a 1:12 weight ratio or 7.7 wt %. This solution was then spin coated on a clean glass slide at 1000 rpm for one minute and allowed to dry overnight. Once dried, the samples were submerged in purified deionized water (Millipore Synergy UV) allowing the sacrificial thin film of PVA to dissolve and thereby release the samples from the substrate.

Parallel tapes were printed using inks at various concentrations of ABS. The width and thickness of the tapes produced by each ink was measured using a Bruker DektakXT stylus profilometer. The ink used for tape-based matrix-free composite printing had a 1:12 weight ratio of ABS:ethyl acetate or 8.7 wt %. These tapes had a width of 1.772±0.068 mm and a thickness of 4.911±0.51 μm for an average aspect ratio of approximately 360.

Synthesis of low-adhesion stacked quasi-composites. Planes of parallel tapes were printed separately at a given offset rotation angle using the ink with 8.7 wt % of ABS. At this concentration, the profile of each tape is identical to the single tapes discussed above. The dimensions of each plane of parallel tapes was 20 mm wide by 40 mm long. We tested four rotational patterns of low adhesion quasi-composites, each having 12 layers, with the successive offset angles of the layers as follows: [0°, 15°, 30°, 45°, 60°, 75°, 90°, 105°, 120°, 135°, 150°, 165°], [0°, 30°, 60°, 90°, 120°, 150°, 0°, 30°, 60°, 90°, 120°, 150°], [0°, 45°, 90°, 135°, 0°, 45°, 90°, 135°, 0°, 45°, 90°, 135°], [0°, 90°, 0°, 90°, 0°, 90°, 0°, 90°, 0°, 90°, 0°, 90°]. Note that these offset angles are given as absolute angles with respect to a fixed orientation. The relative offset angle with respect to the previous layer within each example quasi-composite would be 15°, 30°, 45°, and 90°, respectively. Each layer was dried overnight before it was submerged in Millipore water to dissolve the PVA and release the ABS tapes. The layers were stacked manually in the order they were printed to allow each adjacent layer to be offset by the appropriate offset angle. These wet samples dried overnight to remove all water between the layers.

Synthesis of welded quasi-composites. Planes of parallel tapes were printed directly on top of each other at a given offset rotation angle using the ink with 8.7 wt % of ABS. At this ink concentration, the profile of each tape is identical to the single tapes discussed above. Because the complete sample was being directly printed, the samples could be printed into a dogbone shape with an internal width of 12 mm and length of 24 mm. We used the same four rotational patterns as the stacked samples. The samples dried overnight before their PVA removal bath in purified, deionized water.

Mechanical characterization. All mechanical data was taken using an MTS C42.503 electromotive test system. Load data was recorded using an MTS 100N load cell. The specimens were held using MTS Screw Action Grips. The tensile experiments were conducted at constant rate of 4 mm/min with an initial grip separation of 30 mm.

We made tape-based quasi-composites using tapes having the same composition and dimensions. Low-adhesion tape-based quasi-composites, also referred to as “stacked quasi-composites”, were compared with welded quasi-composites and single tapes. The results are shown in Table 1 below, with the numbers in parentheses corresponding to the percentage change relative to a single tape.

TABLE 1

| Quasi- | Rotation | | | |
|---|---|---|---|---|
| Composite | Angle (°) | Toughness (kJ/m³) | Tensile Strength (MPa) | Modulus (GPa) |
| Single Tape | — | 222 ± 45 | 23.3 ± 1.1 | 1.48 ± 0.05 |
| Stacked | 15 | 792 ± 75 (256.2) | 29.6 ± 1.1 (27.2) | 1.27 ± 0.04 (−14.3) |
| | 30 | 787 ± 126 (253.8) | 29.6 ± 1.2 (27.2) | 1.27 ± 0.07 (−14.3) |
| | 45 | 805 ± 85 (262.1) | 30.6 ± 0.6 (31.5) | 1.34 ± 0.04 (−9.1) |
| | 90 | 423 ± 62 (90.0) | 24.2 ± 1.6 (3.9) | 1.05 ± 0.07 (−28.8) |
| Welded | 15 | 870 ± 69 (291.3) | 27.0 ± 1.3 (15.9) | 1.48 ± 0.07 (0.4) |
| | 30 | 636 ± 46 (186.1) | 26.7 ± 1.6 (14.6) | 1.51 ± 0.08 (2.0) |
| | 45 | 497 ± 54 (123.5) | 25.1 ± 1.8 (7.9) | 1.47 ± 0.07 (−0.6) |
| | 90 | 264 ± 48 (18.9) | 18.3 ± 1.2 (−21.3) | 1.28 ± 0.07 (−13.1) |

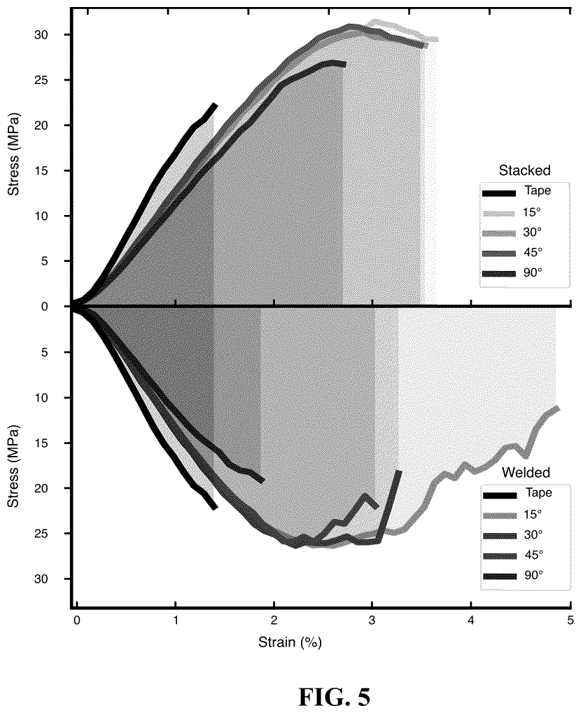

FIG. 5 shows stress-strain curves for the various compositions, including single tape compositions, low-adhesion tape-based quasi-composites (“stacked”), and welded tape-based quasi-composites (“welded”). The offset angles between various layers are identified in the figure. Stress-strain curves for the stacked quasi-composites are shown in the top portion of the figure, while stress-strain curves for the welded quasi-composites are shown in the bottom portion of the figure. Stress-strain curves for the single tape compositions, used as a control, are shown in both the top and bottom portions of the figure.

For the stacked quasi-composites averaged across all offset rotation angles, we observed a 22% increase in the tensile strength (TS), with a peak enhancement of 31% for the 45° samples. The average toughness improved a remarkable 215% with a maximum of 262% for low-adhesion quasi-composites made with a 45° rotation angle. This significant enhancement was achieved despite a 16% decrease in the modulus and was largely due to an average 127% increase in the strain-at-break.

For the welded quasi-composites, we measured an average TS increase of only 4%. However, this number is skewed by the 21% decrease in TS of the 90° samples while the 15°, 30°, and 45° samples increased the TS by 16%, 14%, and 8%, respectively. A linear increase in the strain-at-break from 59% to 255% going from the 90° to 15° samples results in a similar increasing trend from 19% to 291% in the toughness for the same rotation angles. Unlike the low-adhesion quasi-composites that decreased in modulus, these welded quasi-composite samples had no significant change in the modulus.

These mechanical results can be rationalized by considering the mechanics of the single tape-tape junctions within the quasi-composites. At the single junction level, the difference is the strength of the adhesion. We measured the phenomenological adhesive strength to be 1.85 mN/mm for the low-adhesion quasi-composite and 116 mN/mm (about 60 times higher) for the welded quasi-composite. For reference, ordinary Scotch® tape has an adhesive strength of 10 mN/mm (Skopic, B. H., et al., “Self-strengthening tape junctions inspired by recluse spider webs”, Materials Horizons (2022) doi:10.1039/d2mh00403h), which is over five times stronger than the adhesion between our low-adhesion tapes but still over an order of magnitude lower than the strength of the welded junctions. Welded junctions have much stronger adhesion because the polymer chains of the two tapes intermingle from the solvent partially dissolving the previously printed layer. Accordingly, the low-adhesion junctions can engage in high-strain failure modes such as elastic shear at the interface or local peeling. However, the welded junctions have virtually no mobility at the junction and experience tensile failure of the tape, a low-strain failure mode.

In the stacked tape-based quasi-composites, the tapes within the low-adhesion samples can rotate in the plane. This rotation creates additional length not due to elastically stretching the tapes, but rather a pseudo-ductility which decreases the measured modulus of the low-adhesion quasi-composites. In contrast, the welded junctions are effectively locked in place, preventing the rotation and pseudo-ductility. Thus, the welded quasi-composites have roughly the same modulus as the reference tapes.

Tensile strength increased for both sets of quasi-composites. In typical fiber-reinforced composites, the tensile strength is approximately a linear combination of the tensile strengths of the reinforcing fibers and the matrix proportional to the weights of their respective volume fractions. Thus, the maximum possible tensile strength is the tensile strength of the reinforcing fibers. Here, the offset tape is analogous to a fiber reinforcement. However, the tensile strength in the quasi-composites was significantly higher than the tensile strength of the reinforcing fiber (i.e., the tape) in both the low-adhesion and welded quasi-composites. The quasi-composites resist failure for much longer than the individual tapes.

Generally speaking, material failure is initiated by stress concentration around an imperfection within the material. As stress concentrates, the region around the imperfection will begin to plastically strain, thereby causing the cross-sectional area perpendicular to the tensile direction to decrease. This phenomenon is called necking. This process concentrates more stress in the plastically deforming region until the material breaks. Necking can be reduced by adhering two materials that break at different strain levels. When the two adhered materials reach a strain level where the low strain-at-break material would begin to neck, the interfacial adhesion between the two materials resists the necking movement, which prevents the cross-sectional area from decreasing and stress from concentrating further. Thus, the material that would break at low strains reaches much higher strains.

Without wishing to be bound by theory, we believe that tape-based quasi-composites can leverage the necking prevention phenomenon because adjacent layers of tapes experience different levels of strain due to the pseudo-ductility and because they feature different orientations relative to the direction in which the external load is applied to the composite. Layers of tapes within the quasi-composites extend in the tensile direction (i.e., strain) in two ways: (i) elastic strain of the tapes directly and (ii) rotation in-plane towards the tensile direction. Tapes perfectly aligned with the tensile direction will have the most elastic strain while tapes at larger rotation angles can rotate and have less elastic strain. Accordingly, when the quasi-composite has been strained to the breaking point of an individual tape, only the tapes perfectly oriented in the tensile direction are also at their strain-at-break while other (offset) tapes in the quasi-composite are at lower elastic strain levels because they are also rotating in plane. Combined with the adhesion between adjacent layers of tapes, this uneven straining prevents necking for the oriented tapes and allows the quasi-composites to reach higher strains.

In previous investigations of necking prevention, the tensile strength of the two-material system was approximated by the rule of mixtures. Thus, additional strain allowed the two-material system to reach higher stresses, but the tensile strength is limited by the weaker material. For the tape-based quasi-composites described herein, which are made of a single material that resists necking at each tape-tape junction, any additional strain directly increases the quasi-composite's tensile strength over the tensile limit of an individual tape.

The welded quasi-composites cannot mitigate necking at each tape-tape junction because the adhesion is too strong to allow adjacent tapes to have different strain levels. Thus, necking will occur at lower strains and stresses leading to lower tensile strength relative to the low-adhesion quasi-composites, albeit still higher tensile strength than a single tape.

Many polymeric materials turn white in locations where the polymer is plastically deforming. This phenomenon is known as crazing. The color change occurs because micro-voids open within the polymer matrix, thereby causing light to scatter. The voids are empty space that decrease the cross-sectional area of the material. Voids increase in size and spread perpendicularly to the direction of force. Continued straining causes the micro-voids to grow into cracks that propagate through the material leading to failure. This color change allows us to visualize patterns of plastic deformation and the orientation of force within our quasi-composites.

Tape-tape junctions within the stacked quasi-composites (i.e., low-adhesion quasi-composites) have more dynamic failure than the welded quasi-composites because they have much lower interfacial adhesive strength. The stacked quasi-composites dissipate stress by transferring the load between individual tapes through their adhesive interfaces. Tapes that are not parallel to the direction of the external load can rotating in plane to provide additional length to the system without locally straining the tapes, which leads to shear stresses a the interface. Tapes featuring orientations close to the applied tensile load are elongated, which makes them narrower in an amount dictated by the Poisson ratio, and may eventually lead to the onset of necking. Both the narrowing of the tapes and the onset of necking represents a lateral contraction, more or less perpendicular to the direction of the applied external load. This leads to additional interfacial shear stresses, especially when tapes in the layer directly above or below make a greater angle with the external load, and are thus subject to less lateral length changes. Plastic deformation occurs in areas where tapes intersect.

### INCORPORATION BY REFERENCE

All publications, patents, and patent applications cited herein are hereby expressly incorporated by reference in their entirety and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

The articles “a” and “an” are used herein to refer to one or to more than one (i.e., to at least one) of the grammatical object of the article. By way of example, “a tape” means one tape or more than one tape.

Any ranges cited herein are inclusive, e.g., “between 0.1 and 45 degrees” includes 0.1 degrees and 45 degrees.

1. A material composition comprising at least four stacked layers of tapes,
wherein each of said tapes has a length, width, and thickness;
wherein the length of each of said tapes is its longest axis, and the thickness of each of said tapes is its shortest axis;
wherein the ratio of the length of a given tape to its width is at least two;
wherein the ratio of the width of a given tape to its thickness is at least 20;
wherein each of said layers comprises at least three roughly parallel tapes;
wherein said tapes from adjacent layers contact each other at junctions;
wherein said tapes from at least three of said layers are offset at offset angles between about 0.1 degrees and about 45 degrees along the long axis of the tapes from tapes of an immediately adjacent layer;
wherein the maximum spacing between each of at least three roughly parallel tapes within a given layer is no more than twenty times the width of the tape with the biggest width within a given layer;
wherein the maximum thickness of each of said tapes within a given layer is 5 mm; and
wherein the composition has enhanced toughness relative to an equivalent mass of tapes that are not stacked at offset angles.

2. The material composition of claim 1, wherein said tapes from adjacent layers are welded at the junctions.

3. The material composition of claim 1, wherein said tapes from adjacent layers are stacked without welding at the junctions.

4. The material composition of claim 1, wherein the ratio of the width of a given tape to its thickness is at least 50.

5. The material composition of claim 1, wherein the ratio of the length of a given tape to its width is at least ten.

6. The material composition of claim 1, wherein said tapes comprise a polymer.

7. The material composition of claim 5, wherein said tapes comprise a polymer selected from the group consisting of polyethylene, polypropylene, polyvinyl chloride, polystyrene, polyethylene terephthalate, polyurethane, poly(methyl methacrylate), polyethylene glycol, polycarbonate, polyvinylidene fluoride, polytetrafluoroethylene, polyamide, polyacrylonitrile, polybutadiene, polylactic acid, polyvinyl alcohol, polyether ether ketone, polyimide, polyphenylene oxide, acrylonitrile butadiene styrene, polybutylene succinate, polyhydroxyalkanoates, poly-paraphenylene terephthalamide, polyphthalamide, and polybutylene terephthalate.

8. The material composition of claim 1, wherein said tapes comprise a metal.

9. The material composition of claim 1, wherein said offset angles between tapes of adjacent layers are constant throughout the composition.

10. The material composition of claim 1, wherein the material composition is substantially isotropic.

11. The material composition of claim 1, further comprising a matrix selected from the group consisting of a polymeric matrix, a metallic matrix, or a ceramic matrix, wherein said material composition is incorporated into said matrix and the resulting composite has improved physical properties relative to the matrix alone in the absence of said material composition.

12. A method for improving physical properties of a material composition comprising: stacking at least four layers of tapes,
wherein each of said tapes has a length, width, and thickness;
wherein the length of each tape is its longest axis, and the thickness of each tape is its shortest axis;
wherein the ratio of the length of a given tape to its width is at least two;
wherein the ratio of the width of a given tape to its thickness is at least 20;
wherein each of said layers comprises at least three roughly parallel tapes;
wherein the tapes from adjacent layers contact each other at junctions;
wherein tapes from at least three of said layers are offset at offset angles between about 0.1 degrees and about 45 degrees along the long axis of the tapes from tapes of an immediately adjacent layer;
wherein the maximum spacing between each of said at least three tapes within a given layer is no more than twenty times the width of the tape with the biggest width within a given layer;
wherein the maximum thickness of a tape within a given layer is 5 mm; and
wherein the composition has enhanced toughness relative to an equivalent mass of tapes that are not stacked at offset angles.

13. The method of claim 12, wherein said tapes from adjacent layers are welded at the junctions.

14. The method of claim 12, wherein said tapes comprise a polymer.

15. The method of claim 12, wherein said offset angles between tapes of adjacent layers are constant throughout the composition.

16. The method of claim 12, wherein the composition has enhanced toughness by at least 20% relative to an equivalent mass of tapes that are not stacked at offset angles.

17. The method of claim 12, wherein the number of stacked layers of tapes is at least ten.
